(19) United States
(12) Patent Application Publication
(10) Pub. No.: US 2008/0002650 A1
(43) Pub. Date: Jan. 3, 2008

(54) Partially delayed acknowledgment mechanism for reducing decoding delay in WiHD

(76) Inventors: Pengfei Xia, Mountain View, CA (US); Huaning Niu, Sunnyvale, CA (US); Chiu Ngo, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/724,856

(22) Filed: Mar. 16, 2007

Related U.S. Application Data
(60) Provisional application No. 60/817,523, filed on Jun. 28, 2006.

(51) Int. Cl. H04L 12/66

(52) U.S. Cl. 370/338; 370/389; 725/81

(57) ABSTRACT

A method for communicating uncompressed HD information includes a transmitter configured to send over wireless channels data-packets and a receiver configured to receive the data-packets from the transmitter. The wireless receiver includes decoders configured to decode the data-packets and an ACK-processor configured to aggregate and send acknowledge signals having an ACK signal for at least one subpacket from the previous packet and ACK signals for all but the at least one subpacket from the current packet. The transmitter may resend a subpacket of the data-packets corresponding to ACK signals in the second status received from the receiver. The new partially delayed ACK mechanism can substantially improve the system throughput for systems with parallel multiple decoders.

### RELATED APPLICATION

This application claims priority from U.S. Provisional Patent Application Ser. No. 60/817,523, filed on Jun. 28, 2006, which is incorporated herein by reference.

### BACKGROUND

1. Field

The invention relates to wireless communication and more particularly to transmission of uncompressed high definition video information over wireless channels.

2. Description of Related Technology

With the proliferation of high quality video, an increasing number of electronic devices, such as consumer electronic devices, utilize high definition (HD) video which can require about several Gbps (bits per second) in bandwidth for transmission. As such, when transmitting such HD video between devices, conventional transmission approaches compress the HD video to a fraction of its original size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies would suffer from interference issues when several devices that do not have the bandwidth to carry the uncompressed HD signals are connected to the network.

### SUMMARY

One aspect of the invention provides a system and method for communicating uncompressed high definition video information over wireless channels that overcomes a decoding latency problem. Another aspect of the invention provides a system and method for communicating uncompressed high definition video information over wireless channels using a partially delayed acknowledgement mechanism. Still another aspect of the invention also provides a system and method for communicating uncompressed high definition video information over wireless channels using time division unit based parallel decoding by Viterbi decoder parallelization.

According to an aspect of the invention, there is provided a system for a high speed communication system using multiple parallel decoders and a partially delayed acknowledgement mechanism. According to another aspect of the invention, there is provided a method of providing a partially delayed acknowledgement mechanism to solve a decoding latency problem. According to still another aspect of the invention, there is provided a system for a high speed Wireless HD communication system using multiple parallel decoders and a partially delayed acknowledgement mechanism.

A system for high speed Wireless HD communication includes a transmitter and a receiver. The transmitter is configured to send over wireless channels a continuous stream of data-packets, each of which includes a predetermined amount of data that is packaged in a number of subpackets. For example, each data packet may include four sub-packets, of the same or similar size. These data-packets are consecutively, serially transmitted. The receiver is configured to receive the stream of data-packets from the transmitter, and may include a plurality of decoders configured to decode the data. An acknowledgement signal (ACK) is due for each sub-packet received at the receiver, to indicate successful reception or otherwise. The receiver also includes an ACK-processor configured to aggregate acknowledgement signals for multiple subpackets and send to the transmitter, after receiving of the second data-packet, the acknowledge signal including an ACK signal for at least one subpacket of the previous data-packet and ACK signals for all but said at least one subpackets of the current data-packet.

The ACK signal is positive if no errors have been detected in the received data-packet. The ACK signal is of a second status if an error is found in a received data-packet. The transmitter retransmits the previously sent data sub-packet on receiving ACK signals in a second status.

The transmitter further includes memory locations for storing at least one subpacket of the previous transmitted and all subpackets in the currently transmitted data packet, also the receiver further includes memory, location for storing at least one ACK for the previous received subpacket.

The data-packets are provided to and processed by a MAC layer and a PHY layer of the system using an OSI model. Transmitter PHY processing includes applying convolutional codes (or other form of FEC codes) to the incoming data, while receiver PHY processing includes a plurality of decoders, such as Viterbi decoders, configured in a parallel structure such that each of the Viterbi decoders decodes a part of the data-packet in a predetermined order.

The transmitter includes a station which works as a sink or a source of video or audio data, such as a DVD player and a computer. The receiver includes a device coordinator as a sink of the video or audio data, such as an HD TV and media storage device.

A method for reducing decoding delay in a Wireless HD communication system is also provided. The method includes: transmitting, by a transmitter and over wireless channels, a series of data-packets which are consecutively serially sent, wherein each of the data-packets includes a predetermined number of subpackets (TDUs); receiving, by a receiver, a continuous stream of data-packets; processing the stream of data-packets to produce an ACK signal for each of the subpacket inside each and every data-packets; aggregating and sending, by the receiver to the transmitter after receiving the current data-packet, an ACK frame including an ACK signal for the last subpacket from the previous data packet and ACK signals for all but the last subpacket from the current packet; and retransmitting the corresponding subpackets that are indicated as not successfully received by the aggregated ACK signal.

Prior to transmission of the data-packets, the method further includes: receiving raw data from a higher layer including video and audio data for the Wireless HD communication systems; packetizing the raw data into the series of data-packets; and encoding the data-packet using convolutional codes.

The process of processing the decoded subpackets includes: checking the decoded subpackets to produce ACK signals corresponding to each subpacket, wherein the ACK signal is set to be of a first status if the subpacket is transmitted successfully, and is set to be of a second status otherwise;

The process of aggregating and sending ACK signals includes: producing the ACK frame by aggregating the ACK signals for the last subpacket from the previous packet and the ACK signals for all but the last subpacket in the current packet; and sending the ACK frame back to the transmitter.

The process of retransmitting includes: receiving the ACK frame from the receiver at the transmitter, wherein the ACK frame includes the ACK signal for the last subpacket of the previous data-packet and the ACK signals for the first (N−1) of the current data-packet; checking the received ACK frame; determining if each of the received ACK signals is of the first or second status; restoring, from the internal memory location, the subpackets corresponding to ACK signals in a second status; and retransmitting the restored or retrieved subpacket to the receiver. The memory locations include a buffer, wherein the size of the buffer is determined by duration of one subpacket and a transmission throughput between the transmitter and the receiver.

Another method of reducing decoding delay in a Wireless HD communication system is provided. The method includes: receiving raw data from a higher layer including video and audio data for the Wireless HD communication systems; packetizing the raw data into data-packets, while each data packet is composed of a number of subpackets; encoding the data-packets; transmitting subpackets of the current data-packet to the receiver; receiving a ACK frame from the receiver, wherein the ACK frame includes an ACK signal for a last subpacket from the previous data-packet and ACK signals for the current data-packet except for the last subpacket; checking the received ACK frame; determining if each of the received ACK signals corresponding to the subpackets decoded in the receiver is of the first or second status; restoring from internal memory the subpackets corresponding to ACK signals in a second status; and retransmitting the restored subpackets to the receiver. The memory locations include a buffer, with the size of the buffer being determined by duration of one subpacket and a transmission speed of the transmitter and the receiver.

Still another method is provided of reducing decoding delay in a Wireless HD communication system having a transmitter for transmitting a series of packetized and encoded data-packets, each of which includes a predetermined number, N, of subpackets including subpacket(1), subpacket(2), . . . , subpacket(N). The method includes: receiving the packetized and encoded subpackets of the second data-packet from the transmitter; distributing subpackets to N decoders; decoding subpackets with the decoders; checking the decoded subpackets to produce ACK signals corresponding to the subpackets of the current data-packet; restoring the ACK signal for the last subpacket of the previous received packet; producing an ACK frame by aggregating those ACKs together; and sending the ACK frame back to the transmitter; and receiving the subpackets which the transmitter would be retransmitting.

The decoders include Viterbi decoders which are configured to decode the received subpackets in parallel. The memory locations include a buffer of a size which is determined by duration of one subpacket and a transmission speed of the transmitter and the receiver.

### BRIEF DESCRIPTION OF THE DRAWINGS

FIG. 1 is a functional block diagram of a wireless network that implements uncompressed HD video transmission between wireless devices according to one embodiment of the system and method;

FIG. 2 is a functional block diagram of an exemplary communication system for transmission of uncompressed HD video over a wireless medium, according to one embodiment of the system and method;

FIG. 3 is a block diagram illustrating components of a transmitter chain;

FIG. 4 is a block diagram illustrating components of a forward error correction module of FIG. 3;

FIG. 5 is a block diagram illustrating components of a receiver chain;

FIG. 6 is an illustration of a WiHD system comprising LRP and HRP channels;

FIG. 7 is a time-line diagram showing an ACK mechanism and a frame format;

FIG. 8 is a block diagram showing a convolutional encoder;

FIG. 9 is a schematic block diagram showing an embodiment of a parallel Viterbi decoder structure at the receiver side;

FIG. 10 is a diagram showing a partially delayed ACK mechanism and corresponding frame format according to an embodiment of the invention;

FIG. 11 is a flowchart illustrating the process of transmitting and receiving data packets and ACKs according to another embodiment of the invention; and

FIG. 12 is a block diagram illustrating the transmitter and the receiver with memory locations.

### DETAILED DESCRIPTION OF EMBODIMENTS

The following detailed description of certain embodiments presents various descriptions of specific embodiments of the invention. However, the invention can be embodied in a multitude of different ways as defined and covered by the claims. In this description, reference is made to the drawings wherein like parts are designated with like numerals throughout.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

### Overview of Wireless HD Communication System

Certain embodiments provide a method and system for transmission of uncompressed HD video information from a transmitter to a receiver over wireless channels.

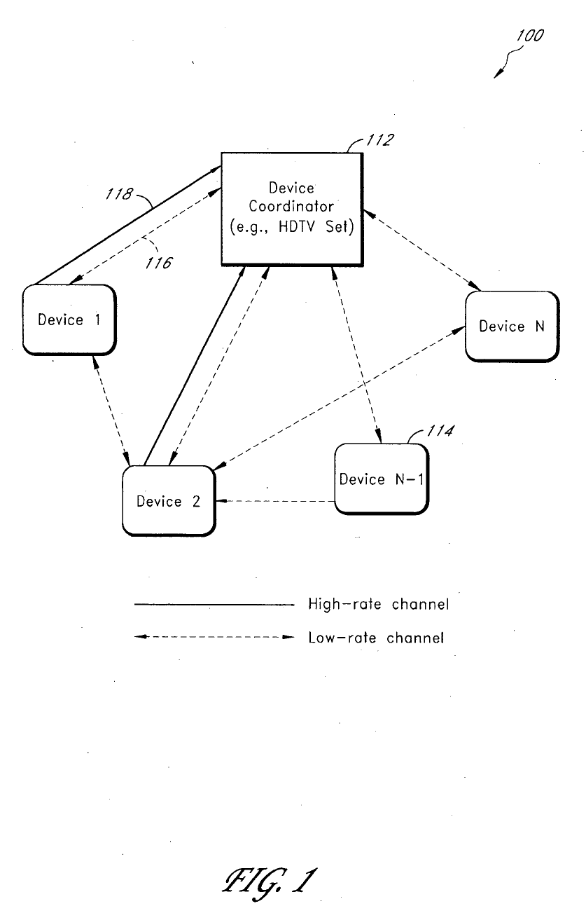

A wireless video area network (WVAN) consists of one Coordinator and one or more stations as shown in FIG. 1. The Coordinator is normally, but not always, a device that is a sink for audio or video data, e.g., a display, but also potentially a media storage device like a personal video recorder (PVR). A station, on the other hand, is a device that has media that it can either source or sink, potentially at the same time.

The computing and networking industry uses the Open Systems Interconnection Reference Model (OSI model) for communications and computer network protocol design. The OSI model is a hierarchical structure of seven layers that defines the requirements for communications between two devices. The seven layers include application layer, presentation layer, session layer, transport layer, network layer, data link layer, physical layer.

Of particular relevance here are the data link and physical layers. The data link layer provides the functional and procedural means to transfer data between network entities and to detect and possibly correct errors that may occur in the physical layer. The data link layer is divided into two sublayers: the Media Access Control (MAC) layer and the Logical Link Control (LLC) layer. The MAC sublayer controls how a computer on the network gains access to the data and permission to transmit it. The LLC layer controls frame synchronization, flow control and error checking. The physical (PHY) layer defines all the electrical and physical specifications for devices.

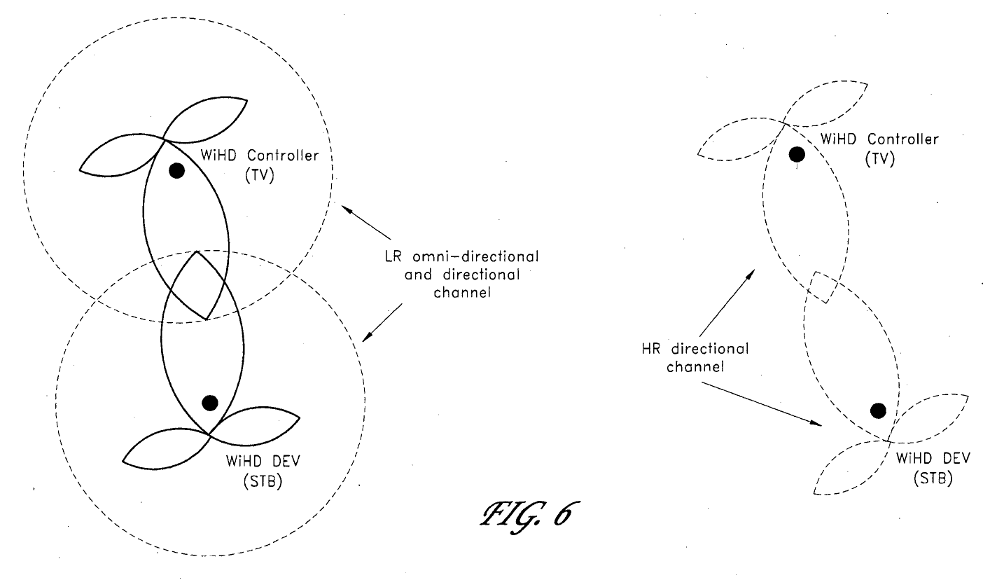

The high-rate PHY (HRP) is a PHY that supports multi-Gb/s throughput at distance less than 10 meters through adaptive antenna technology. Because of this, the HRP is highly directional and normally are used mainly for unicast connections as shown in FIG. 1 and FIG. 6. The HRP is optimized for the delivery of uncompressed high-definition video, and other data can be communicated using the HRP. To support multiple video resolutions, the HRP has more than one data rates defined. The HRP carries isochronous data such as audio and video, asynchronous data, MAC commands, antenna steering information, and higher layer control data for A/V devices.

The low-rate PHY (LRP) is a multi-Mb/s bidirectional link that also provides a range of 10 meters. Multiple data rates are defined for the LRP, with the lower data rates having near omni-directional coverage while the highest data rates are directional as shown in FIG. 1 and FIG. 6. LRP can be used for both unicast and broadcast connections. Furthermore, because all stations support the LRP, it can be used for station-to-station links. The LRP supports multiple data rates, including directional modes, and is used to carry low-rate isochronous data such as audio, low-rate asynchronous data, MAC commands including the beacon frame, acknowledgements for HRP packets, antenna steering information, capabilities information, and higher layer control data for A/V devices.

The HRP and LRP operate in overlapping frequency bands and so they are coordinated in a TDD (time division duplexing) manner by the MAC. The WVAN supports at least one uncompressed 1080p video stream with associated audio at a time. Multiple lower rate video streams, e.g., two 1080i video streams, can also be supported.

The WVAN supports two types of devices, coordinator and station. The coordinator controls the timing in the piconet, keeps track of the members of the WVAN, transmits or receives data using the LRP or using the HRP. The station transmits and receives data using the LRP, initiates stream connections, and transmits or receives data using the HRP. The station may be capable of acting as a coordinator in the WVAN. Such a station is referred to as being coordinator-capable.

In addition to the two MAC personalities of coordinator and station, each device in the WVAN will have one of four different PHY capabilities; HRO, HRRX, HRTX, and HRTR. HRO is a device that is not able to either receive or transmit using the HRP. HRRX is a device that is able to receive in the HRP, but is not able to transmit using the HRP. HRTX is a device that is able to transmit in the HRP, but is not able to receive using the HRP. HRTR is a device that is able to both transmit and receive using the HRP.

All compliant WirelessHD devices are able to transmit and receive using the LRP. Both the HRP and LRP may provide multiple data rates.

### Detailed Operation of the Wireless HD Communication Systems

Some embodiments in a wireless high definition (HD) audio/video (A/V) system will now be described.

FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple A/V stations 114 (e.g., Device 1 . . . . Device N).

The A/V stations 114 utilize a low-rate (LR) wireless channel 116 (dashed lines in FIG. 1), and may use a high-rate (HR) channel 118 (heavy solid lines in FIG. 1), for communication between any of the devices. The device coordinator 112 uses a low-rate channel 116 and a high-rate wireless channel 118, for communication with the stations 114. Each station 114 uses the low-rate channel 116 for communications with other stations 114. The high-rate channel 118 supports single direction unicast transmission over directional beams established by beamforming, with e.g., multi-Gb/s bandwidth, to support uncompressed HD video transmission. For example, a set-top box can transmit uncompressed video to a HD television (HDTV) over the high-rate channel 118. The low-rate channel 116 can support bi-directional transmission, e.g., with up to 40 Mbps throughput in certain embodiments. The low-rate channel 116 is mainly used to transmit control frames such as acknowledgement (ACK) frames. For example, the low-rate channel 116 can transmit an acknowledgement from the HDTV to the set-top box. It is also possible that some low-rate data like audio and compressed video can be transmitted on the low-rate channel between two devices directly. Time division duplexing (TDD) is applied to the high-rate and low-rate channel. At any one time, the low-rate and high-rate channels cannot be used in parallel for transmission, in certain embodiments. Beamforming technology can be used in both low-rate and high-rate channels. The low-rate channels can also support omni-directional transmissions.

In one example, the device coordinator 112 is a receiver of video information (hereinafter “receiver 112”), and the station 114 is a transmitter of the video information (hereinafter “transmitter 114”). For example, the receiver 112 can be a sink of video and/or audio data implemented, such as, in an HDTV set in a home wireless network environment which is a type of WLAN. The transmitter 114 can be a source of uncompressed video or audio. Examples of the transmitter 114 include a set-top box, a DVD player or recorder, digital camera, camcorder, and so forth.

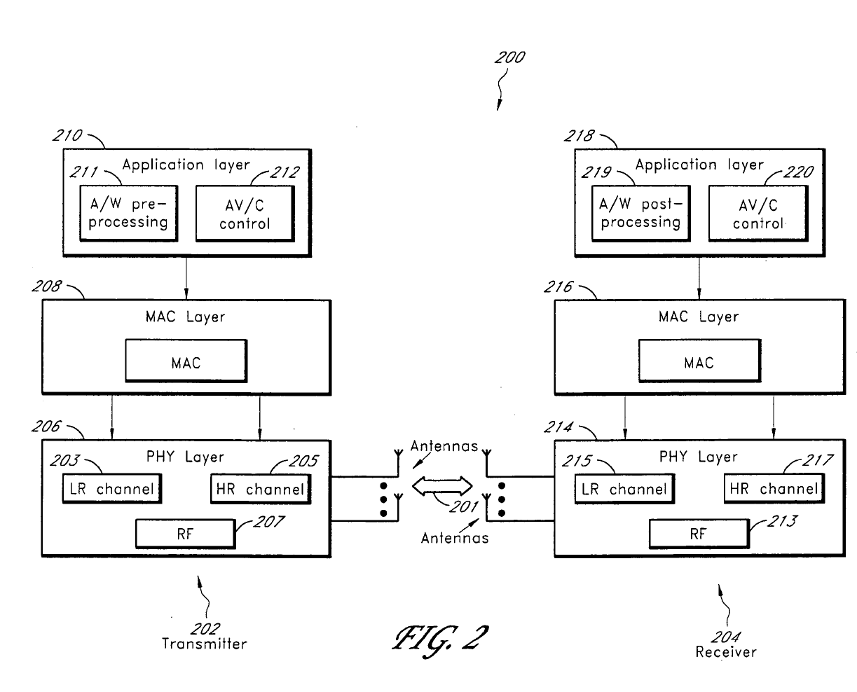

FIG. 2 illustrates a functional block diagram of an example communication system 200. The system 200 includes a wireless transmitter 202 and wireless receiver 204. The transmitter 202 includes a physical (PHY) layer 206 and a media access control (MAC) layer 208. Similarly, the receiver 204 includes a PHY layer 214 and a MAC layer 216. The PHY and MAC layers provide wireless communication between the transmitter 202 and the receiver 204 via antennas through a wireless medium 201.

The transmitter 202 further includes a partitioning module 210, a packetization module 212, and an encoding module 211. The partitioning module 210 implements partitioning steps on uncompressed video from higher levels, and the packetization module 212 generates the packets. The encoding module 211 performs encoding (e.g., differential pulse code modulation (DPCM), binary XOR (bXOR), etc.).

The PHY/MAC layers of the transmitter 202 add PHY and MAC headers to packets and transmit the packets to the receiver 204 over the wireless channel 201. In the wireless receiver 204, the PHY/MAC layers 214, 216 process the received packets. The receiver 204 further includes a decoding module 219, a de-packetization module 220, and a de-partitioning module 218.

The decoding module 219 receives the processed packets from the PHY/MAC layers and performs inverse steps of the encoding module 211.

The de-packetization module 220 provides the bits in the packets to the de-partitioning module 218. The de-partitioning module 218 performs an inverse partitioning method of the partitioning module 210 to regenerate the uncompressed video from the partitioned pixels in the packets. The modules 211 and 212 may be components of the MAC layer 208. Similarly, the modules 219 and 220 may be components of the MAC layer 216.

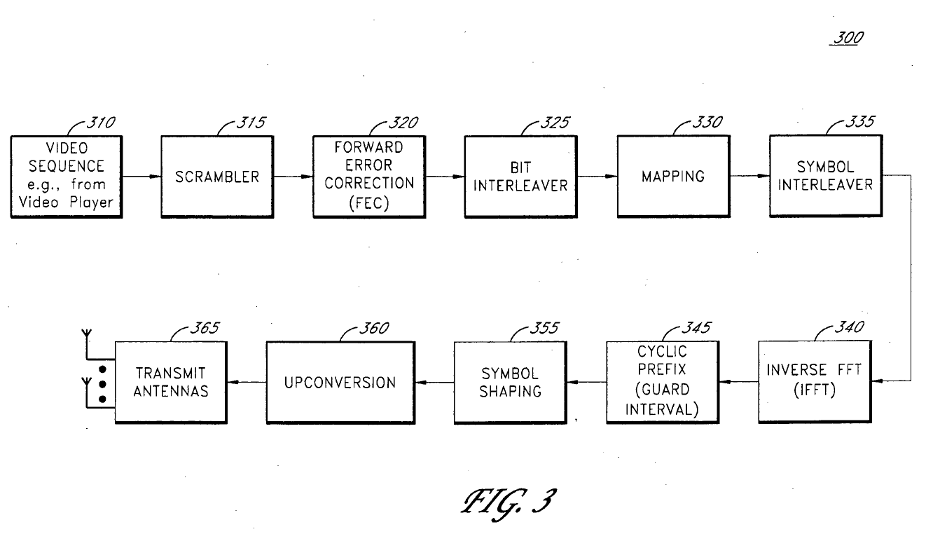

Referring to FIG. 3, a transmit chain 300 of modules, subsystems or devices, such as used in the PHY block 206 (FIG. 2), will be described. It will be appreciated that these modules, subsystems, or devices can be implemented using hardware, software or a combination of both. A video sequence 310 having video data, such as from a video player or other device, is input into a scrambler 315. The scrambler 315 transposes or inverts signals or otherwise encodes data to make the data unintelligible at a receiver not equipped with a corresponding descrambling device. Another benefit of scrambling is to make transmitted sequence less susceptible to detection error and more friendly for transmit power amplifiers. Scrambling is accomplished by the addition (or XORing) of components to the original signal or the changing of some important component of the original signal in order to make extraction of the original signal difficult. Examples of the latter can include removing or changing vertical or horizontal sync pulses in video signals.

A forward error correction (FEC) subsystem 320 receives output from the scrambler and provides protection against errors during wireless data transmission. The FEC subsystem 320 adds redundant data to the scrambled video data input to the subsystem. The redundant data allows the receiver to detect and correct errors without asking the transmitter for additional data. In adding redundant data to the video data, the FEC subsystem 320 can use error-correcting encoders, such as a Reed-Solomon (RS) encoder and a convolutional code (CC) encoder, with possibly an interleaver placed in between the RS encoder and the convolutional encoder. In other embodiments, the FEC subsystem 320 may use various other encoders, including, but not limited to, a Golay encoder, a Hamming encoder, and a Bose, Ray-Chaudhuri, Hocquenghem (BCH) encoder.

The output of the FEC 320 is sent to a bit interleaver 325. The bit interleaver 325 rearranges a sequence of data bits received from the FEC 320. The bit interleaver 325 serves to provide further error-protection over video data transmitted over a wireless medium. The output of the bit interleaver 325 is sent to a mapper 330. The mapper 330 maps data bits to complex (IQ) symbols (frequency domain data). The complex symbols are used to modulate a carrier for the wireless transmission described above. The mapper 330 can use various modulation schemes, including, but not limited to, Binary Phase-Shift Keying (BPSK), Quadrature Phase-Shift Keying (QPSK), and Quadrature Amplitude Modulation (QAM). In one embodiment, the mapper 330 is a QAM mapper, for example, a 16-QAM mapper or 64-QAM mapper. QAM is a modulation scheme which conveys data by modulating the amplitude of two carrier waves. The two waves, usually sinusoids, are out of phase with each other by 90° and thus are called quadrature carriers. The number, 16 or 64, in front of “QAM” refers to the total number of symbols to which the mapper can map groups of data bits. For example, a 16-QAM mapper converts 4-bit data into 2⁴=16 symbols. Typically, for QAM mappers, a constellation diagram is used for representing such symbols.

The output of the mapper 330 is sent to a symbol interleaver 335 that rearranges the sequence of complex symbols output from the mapper. The illustrated symbol interleaver 335 is positioned after the mapper 330. In other embodiments, the symbol interleaver 335 may be positioned between the FEC and the mapper 330 in place of the bit interleaver. In such embodiments, the symbol interleaver permutes the predetermined number of bits as a symbol group. For example, in an embodiment where a QAM mapper maps four data bits to a complex symbol, the symbol interleaver is configured to interleave groups of four data bits.

In an embodiment where the symbol interleaver 335 is positioned after the mapper 330, the symbol interleaver rearranges the sequence of the symbols output from the mapper 330. In one embodiment, the symbol interleaver 335 can include a random interleaver which employs a fixed random permutation order and interleaves symbols according to the permutation order. In other embodiments, the symbol interleaver 335 can include a block interleaver. A block interleaver accepts a set of symbols and rearranges them without repeating or omitting any of the symbols in the set. The number of symbols in each set is fixed for a given interleaver. The interleaver's operation on a set of symbols is independent of its operation on all other sets of symbols.

The output of the symbol interleaver 335 is sent to an inverse Fast Fourier Transform (IFFT) module 340. The IFFT 340 transforms frequency domain data from the error-correcting, mapping and interleaving modules back into corresponding time domain data. The IFFT module 340 converts a number of complex symbols, which represent a signal in the frequency domain, into the equivalent time domain signal. The IFFT module 340 also serves to ensure that the carrier signals produced are orthogonal. The output of the IFFT 340 is sent to a cyclic prefix adder 345 so as to decrease receiver complexity. The cyclic prefix adder 345 may also be referred to as a guard interval adder. The cyclic prefix adder 345 adds a cyclic prefix interval (or guard interval) to an IFFT-processed signal block at its front end. The duration of such a cyclic prefix interval may be 1/32, 1/16, ⅛, or ¼ of the original signal block duration.

A symbol shaping module 355 interpolates and low-pass filters the packet signal generated from the IFFT module 340 and the cyclic prefix adder 345. The output of the symbol shaping module 355 is a complex baseband of the output signal of the IFFT module 340. An upconverter 360 upconverts the output of the symbol shaping module 355 to an intermediate frequency (IF). The upconverter 360 is further configured to upconvert the upconverted signal to a radio frequency (RF). A set of transmit antennas 365 transmit the signal output from the upconverter 360 over a wireless medium, such as the wireless channel 201 (FIG. 2) to a receiver. The transmit antennas 365 can include any antenna system or module suitable for wirelessly transmitting uncompressed HD video signals.

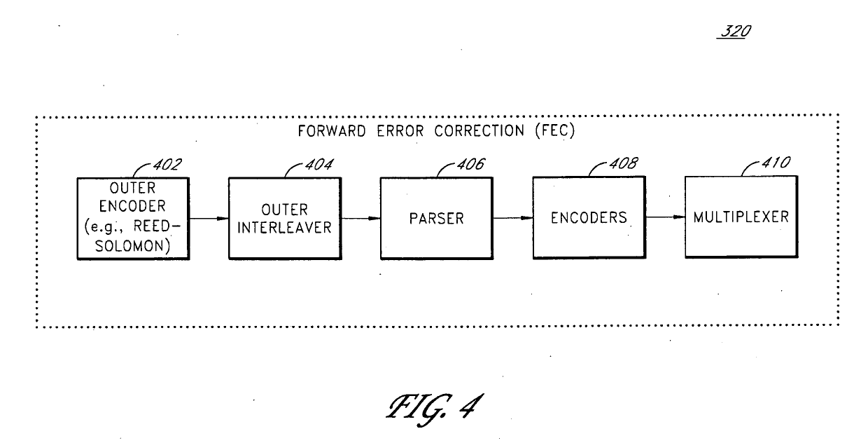

FIG. 4 is a block diagram showing a forward error correction module of FIG. 3. The forward error correction (FEC) 307 includes an outer encoder 402, an interleaver 404 (which is often called an outer interleaver in the system), a parser 406, encoders 408, and a multiplexer 410.

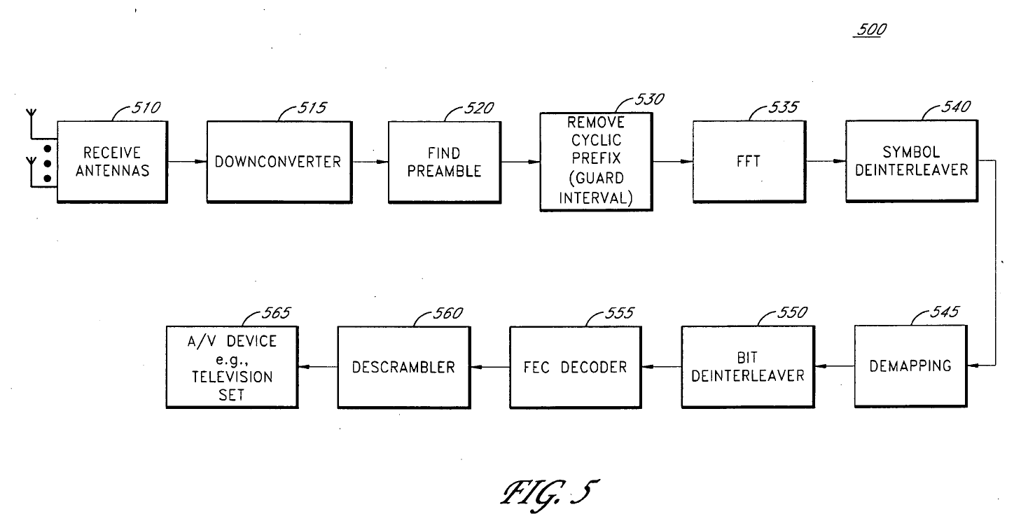

Referring to FIG. 5, a receiver chain 500 of modules, subsystems or devices, such as used in the PHY block 214 (FIG. 2), will be described. The receiver chain modules perform an inverse process to that of the transmitter chain 300 of FIG. 3. The receiver 500 receives an RF signal via the wireless channel 201 (FIG. 2) at receive antennas 510 from the transmit antennas 365 of the transmitter 300. A downconverter 515 downconverts the RF signal to a signal of a frequency suitable for processing. Then, an analog-to-digital converter (not shown) converts the signal into a digital signal. A preamble finder 520 then locates the preamble portion of the digital signal. A cyclic prefix remover 530 removes the cyclic prefix from the signal. Next, a fast Fourier transform (FFT) module 535 transforms the signal (a time-domain signal) into a frequency-domain signal. The output of the FFT 535 is used by a symbol deinterleaver 540 which rearranges the FFT output for a demapper 545. The demapper 545 converts the complex signal into a bit stream. A bit deinterleaver 550 rearranges the bit stream in the original bit stream sequence as before the bit interleaver 325 of FIG. 3.

Subsequently to the bit deinterleaving, a FEC decoder 555 decodes the bit stream, thereby removing redundancy added by the FEC 320 of FIG. 3. In one embodiment, the FEC decoder 555 includes a parser, a multiplexer, and a plurality of convolutional code (CC) decoders interposed between the parser and the multiplexer. Finally, a descrambler 560 receives the output from the FEC decoder 555, and then descrambles it, thereby regenerating the video data sent from the transmitter 300 of FIG. 3. A video device 565 can now display video using the video data. Examples of the video device include, but are not limited to, a CRT television, an LCD television, a rear-projection television and a plasma display television. It will be appreciated that audio data can also be processed and transmitted in the same manner along with video data by the wireless HD A/V system described above. The audio data can be processed and transmitted using a different wireless transmission scheme. The descrambler 560, FEC decoder 555, bit deinterleaver 550, demapper 545, symbol deinterleaver 540, FFT 535 cyclic prefix remover 530, downconverter 515 and receive antennas 510 of the receiver chain 500 perform analogous but inverse functions of the corresponding scrambler 315, FEC 320, bit interleaver 325, mapper 330, symbol interleaver 335, IFFT 340, cyclic prefix adder 345, upconverter 360 and transmit antennas 365 of the transmit chain 300.

### Increasing the Data-Packet Throughput to the Range of Gbps

There are some concerns and problems in attempting to increase the throughput of the system to the range of Gb/s. The high definition TV has a significantly higher resolution than traditional formats (NTSC, SECAM, PAL) allow. Accordingly, the HD TV must handle significantly more information than the traditional formats. The information delivery rate cannot merely be increased using traditional methods in order to achieve the necessary transmission speed.

For ultra high speed communication systems using convolutional codes to protect data against noise and channel fading, a Viterbi decoder may be used to accomplish the necessary decoding. A Viterbi decoder uses the Viterbi algorithm for decoding a bit stream that has been encoded using Forward error correction based on a convolutional code. However, it is generally very difficult to implement a single Viterbi decoder to decode the ultra high speed data streams on the order of several Giga bps. Viterbi decoder parallelization is generally desired, where multiple Viterbi decoders jointly decode the high speed incoming data subpacket (TDU, time division unit) based parallel decoding is proposed, where multiple Viterbi decoders are used to decode multiple subpackets with each decoder responsible for one subpacket only at a time.

To prevent data loss, there should also be a checking mechanism in the transmitting and receiving of the information especially in the wireless communication. For this purpose, the community of computing and communication uses an ACK system. An ACK is a signal passed between communicating processors or computers to signify acknowledgement, or receipt of response, as part of a communications protocol. For instance, ACK packets are used in the Transmission Control Protocol during establishment and termination of connections in the transmission side and the receiver side respectively.

Using a normal ACK mechanism under such a parallel Viterbi decoder structure, however, seriously limits the subpacket duration and significantly increases the overall overhead. Further, subpacket based parallel decoding using a normal ACK mechanism causes a serious decoding latency problem as further described hereafter. We disclose herein a partially delayed ACK mechanism which is provided to overcome the decoding latency problem, and to increase the overall system efficiency.

FIG. 6 a conceptual diagram illustrating a Wireless HD system having LR and HR channels. The dots stands for the controller and the stations. The circles and football-shaped curves are the ranges for the channels. The HR channels are highly directional because of beamforming while the LR channels are omni-directional.

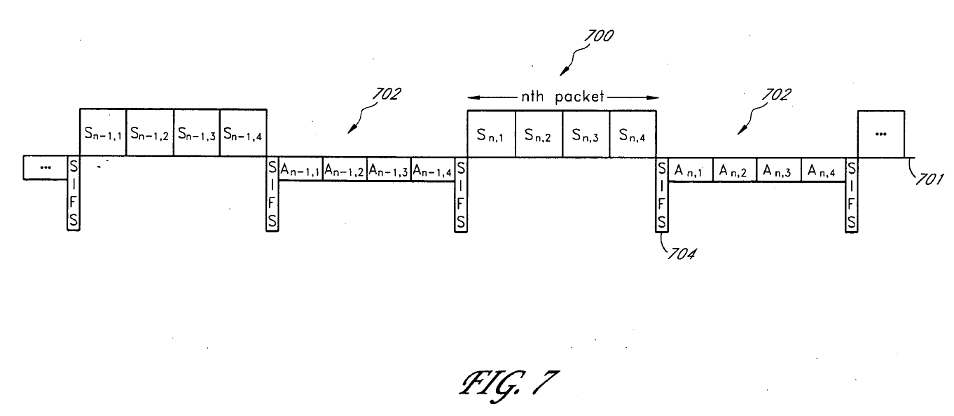

FIG. 7 illustrates a time-line diagram of a conventional frame format and ACK mechanism for an embodiment of WiHD applications. The data stream 700 above the horizontal center line 701 corresponds to a data transmission from the transmitter to the receiver, and the data-packet 702 below the horizontal center line 701 corresponds to a data transmission from the receiver to the transmitter. The period 704 defines the period during which the received data-packet is processed in the receiver side such as SIFS 704. As shown in FIG. 7, the nth packet 700 is divided into 4 sub-packets S_{n,1}, S_{n,2}, S_{n,3}, S_{n,4}, with S_{n,i}, being the ith sub-packet of the nth packet 700. Each sub-packet S_{n,i} is acknowledged through a sub-ACK A_{n,i}. At the end of the nth packet 700, the four sub-ACKs (A_{n,1}, A_{n,2}, A_{n,3}, A_{n,4}) 702, are aggregated together and sent to the transmitter via the feedback link. Upon receiving the four sub-ACKs, the transmitter is able to identify which sub-packet is to be retransmitted if retransmission is necessary. Notice that, between the uplink and downlink transmissions, i.e., between ACK and data frames, a SIFS (small inter frame space) time 704 is needed to account for the processing delay. Normally, all the processing/decoding activities have to be completed during the SIFS time 704 in order to determine the content of the sub-ACKs 702.

Such an ACK mechanism may cause serious problems for ultra high speed (3-4 Gbps) applications like WiHD, when convolutional code is used. Also, it is very difficult and expensive to implement a single gigabit throughput Viterbi decoder using current IC design techniques. An advisable approach would be to use parallelization, i.e., to use multiple parallel Viterbi decoders at the receiver side, with each Viterbi decoder handling only a fraction of the ultra high speed data stream.

The number of Viterbi decoders used depends on other factors such as the decoding speed of the Viterbi decoders. The embodiment illustrated in FIG. 7 uses four Viterbi decoders in a parallel structure, for the purpose of explanation.

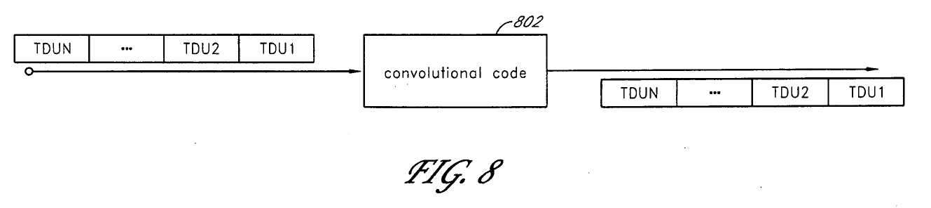

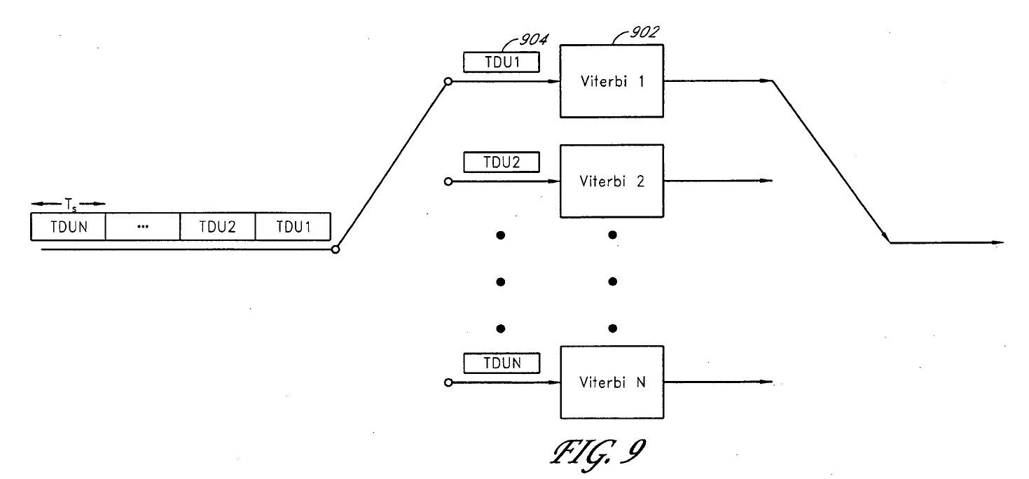

FIG. 8 and FIG. 9 illustrate an example of using multiple parallel Viterbi decoders 902 at the receiver side together with a single convolutional encoder 802 at the transmitter side. Multiple subpackets (TDUs) are formed at the transmitter side. These subpackets are subsequently, sequentially decoded by different Viterbi decoders 902 one by one at the receiver side.

A problem may occur if the subpacket based structure as in FIG. 9 is used for ultra high speed (3-4 Gbps) transmission. For example, suppose the subpacket data rate is N times faster than the processing speed of the Viterbi decoder 902, and suppose the data is divided into N subpackets 904 with each subpacket having duration Ts. It is apparent that each Viterbi decoder takes N*Ts to finish the decoding of each subpacket. Hence, upon receiving the last subpacket in a period, another (N−1)*Ts time is required to finish the decoding of this last subpacket.

For this reason, the subpacket duration Ts has to be very small. However, since every subpacket must be a certain integer number of OFDM (orthogonal frequency-division multiplexing) symbols and includes padding zeros for each subpacket, the small subpacket duration will significantly lower the overall bandwidth efficiency. For example, a typical SIFS time is quite small and on the order of 2 μs. The parallelization factor N depends on the IC design technique, and typically is around 8. Under such cases, the subpacket time has to be less than 300 ns, which corresponds to only about 1 OFDM symbol per subpacket. Thus, the overhead is simply intolerable.

To make the subpacket time duration not be limited by the SIFS time and the parallelization factor N, the following partially delayed ACK mechanism is provided.

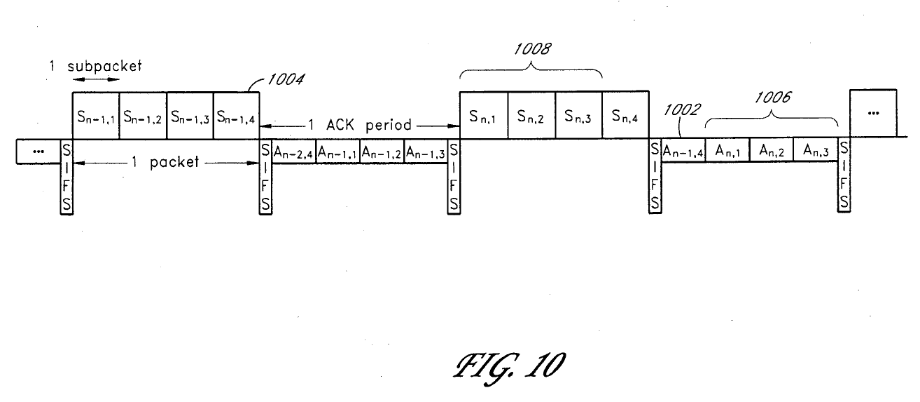

As shown in FIG. 10, inside each packet, the first sub-ACK 1002 is used to acknowledge the last sub-packet 1004 in the previous packet, while the following three sub-ACKs 1006 are used to acknowledge the first three sub-packets 1008 in the current packet. Equivalently, the sub-ACKs are always delayed by 1 sub-packet time duration. Doing so allows enough decoding time (at least one sub-packet duration) for handling all the subpackets in a sub-packet. Essentially, the decoding time is no longer limited by the SIFS time or the parallelization factor N.

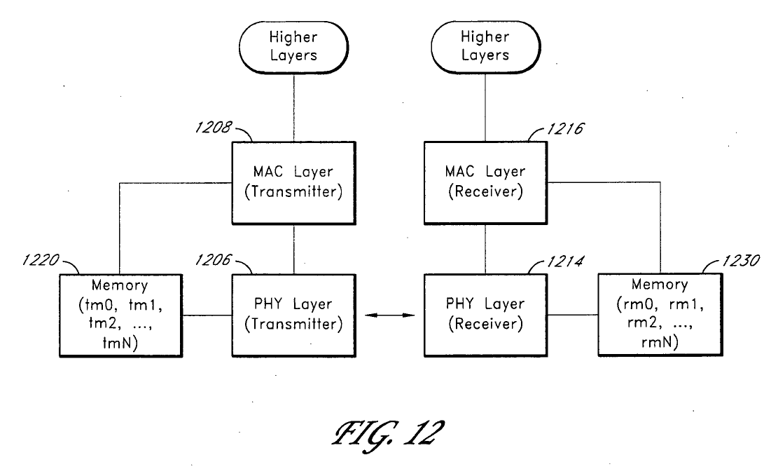

The price paid for this delay in ACK is the introduction of an extra buffer, the size of which is about 1 sub-packet, at both the transmitter and the receiver; tm0 1220 and rm0 1230 respectively as shown in FIG. 12. In a current WiHD, the extra buffer size increase would be around 50 μs*3.8 Gbps=23.75 Kbytes for 1080 p HDTV transmissions, which is not a significant hurdle at all. Hence it is desirable to implement the partially delayed ACK considering the benefit of overcoming the decoding latency problem.

The acknowledgements may be delayed not only by 1 sub-packet time duration as shown in FIG. 10, but also by a predetermined number of sub-packet time durations. For example, an ACK frame may comprise ACK signals for at least two subpackets of the previously sent data-packet and ACK signals for all of the subpackets of the current data-packet except the last at least two subpackets. The size of the extra buffer depends on the number of delayed acknowledgements.

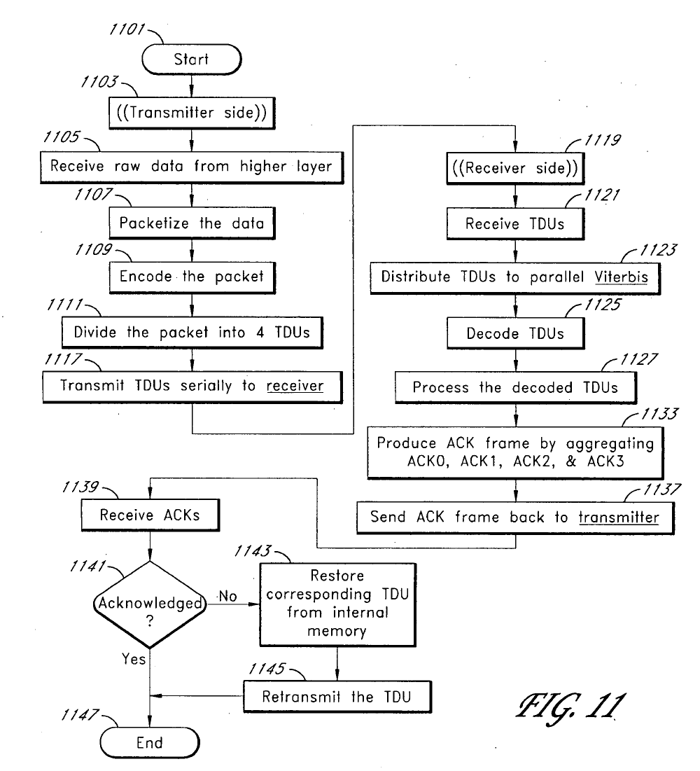

FIG. 11 is a flowchart illustrating the process of transmitting and receiving data-packets and ACK frames. The portion of the process on the left-hand side occurs in the transmitter side 202 of FIG. 2, and the portion of the process on the right-hand side occurs in the receiver side 204 of FIG. 2.

From a start state 1101, the process begins on the transmitter side 1103 when it receives raw data from a higher layer in state 1105. In states 1107 and 1109, the process packetizes and encodes the received raw data in the MAC layer of the transmitter side. Then, the packet or data-packet is divided into, for example, four subpackets in state 1111. If the first and second data-packets are sent from the transmitter to the receiver consecutively, serially, then the memory location tm4 holds the last subpacket of the first data-packet, which was received immediately before the transmitter transmits the second data-packet.

To be prepared to store the last subpacket of the second data-packet, the contents of tm4 must be moved to tm0. So far, five subpackets have been stored in the memory locations; tm0, tm1, tm2, tm3, and tm4. They will be restored or retrieved from the memory locations if a retransmission becomes necessary. Finally, the transmitter sends the subpackets to the receiver in state 1117.

In the receiver side 1119, the receiver receives the subpackets from the transmitter as shown in state 1121. Then the receiver distributes the subpackets to the Viterbi decoders in state 1123. The distributed subpackets are decoded in the Viterbi decoders in state 1125 and the receiver then checks if the transmission was successful and without error in state 1127, wherein the receiver also produces an ACK signal for each of the subpackets according to the checking results. T hen, the receiver restores the delayed ACK signal from a memory location rm0, an ACK signal for the last subpacket of the first data-packet, and produces an ACK frame by aggregating the ACK signal from rm0 and ACK signals for all of the subpackets of the second data-packet except the ACK for the last subpacket of the second data-packet, in this specific example, in state 1133. The receiver sends the ACK frame to the transmitter as in state 1137.

Again on the transmitter side, the transmitter receives the ACK frame from the receiver in state 1139, and determines whether a retransmission is needed or not in state 1141. If the transmission was not successful for at least one of the subpackets, then in state 1143 the transmitter retrieves and retransmits the subpackets corresponding to the ACK signals in the second status as in state 1145 before ending the process in state 1147.

As shown in FIG. 12, the memory locations 1220 in the transmitter side may be connected to the PHY layer 1206, to the MAC layer 1208, or to the PHY layer 1206 and the MAC layer 1208. The memory locations 1230 in the receiver side may be connected to the PHY layer 1214, to the MAC layer 1216, or to the PHY layer 1214 and the MAC layer 1216.

### CONCLUSION

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

What is claimed is:

1. A system for a communication comprising:
a transmitter configured to send, over wireless channels to a receiver, first and second data-packets which are consecutively serially transmitted, each of said data-packets comprising a predetermined number of subpackets, subpackets, configured to receive ACK frame from the receiver, the ACK frame comprising an ACK signal for at least one last subpacket of the first data-packet and ACK signals for all but the at least one last subpacket of the second data-packet, and configured to retransmit subpackets corresponding to failed ACK signals; and
a plurality of memory locations for storing the second data-packet and the at least one subpacket of the first data-packet.

2. The system of claim 1, wherein the data-packets are provided and processed by a MAC layer and a PHY layer of the system using an OSI model.

3. The system of claim 2, wherein the data-packets comprise convolutional codes, and wherein the transmitter comprises a convolutional encoder.

4. The system of claim 1, wherein the transmitter comprises a station which works as a sink or a source of video or audio data, wherein the station comprises a DVD player and a computer.

5. A system of for a communication comprising:
a receiver, configured to receive first and second data-packets from a transmitter,
wherein the receiver comprises a plurality of decoders configured to decode the subpackets and an ACK-processor configured to aggregate and send an acknowledgment frame to the transmitter after receiving the second data-packet, said acknowledgment frame comprising an ACK signal for at least one subpacket of the first data-packet and ACK signals for all but said at least one subpacket of the second data-packet, and wherein the receiver further comprises a plurality of memory locations for storing the ACKs for the second data-packet and the ACK for the at least one subpacket of the first data-packet.

6. The system of claim 5, wherein the data-packets are provided and processed by a MAC layer and a PHY layer of the system using an OSI model.

7. The system of claim 6, wherein the data-packets comprise convolutional codes, and wherein the transmitter comprises a convolutional encoder.

8. The system of claim 6, wherein the plurality of decoders comprise Viterbi decoders configured in a parallel structure, wherein each of the Viterbi decoders decodes a part of the data-packet in a predetermined order.

9. The system of claim 5, wherein the receiver comprises a device coordinator as a sink of the video or audio data, and wherein the device coordinator comprises an HD TV and media storage device.

10. A method of reducing decoding delay in a communication system, comprising:
transmitting, by a transmitter and over wireless channels, a series of data-packets comprising first and second data-packets which are consecutively serially sent, wherein each of the data-packets comprises a predetermined number of subpackets;
receiving, by the transmitter, ACK frame from a receiver, wherein the ACK frame comprises the ACK signal for the last subpacket of the first data-packet and the ACK signals for the first (N−1) subpackets comprising subpacket(1), subpacket(2), . . . , subpacket(N−1) of the second data-packet;
checking the received ACK frame;
determining if each of the received ACK signals corresponding to the subpackets decoded in the receiver is of the first or second status;
restoring the subpackets corresponding to the ACK signals in the second status; and
retransmitting the restored subpackets to the receiver.

11. The method of claim 10, wherein prior to transmitting, the method further comprises:
receiving raw data from a higher layer, said raw data comprising video and audio data for the communication systems;
packetizing the raw data into the series of data-packets; and
encoding the data-packet.

12. The method of claim 11, wherein the act of encoding comprises using convolution codes.

13. The method of claim 11, wherein the act of encoding comprises using concatenation of RS codes and convolutional codes with an interleaver in between.

14. The method of claim 10, wherein the act of transmitting comprises:
storing a last subpacket of the first data-packet previously sent;
dividing the second data-packet into a predetermined number, N, of subpackets comprising subpacket(1), subpacket(2), . . . , subpacket(N);
storing the subpackets, subpacket(i) with index i running from 1 to N; and
transmitting subpackets of the second data-packet to the receiver.

15. A method of reducing decoding delay in a communication system comprising:
receiving first and second data-packets at a receiver;
processing the first and second received data-packets to produce an ACK signal for each of the subpackets of the first and second data-packets; and
aggregating and sending, after receiving the second data-packet, an ACK frame to a transmitter, the ACK frame comprising an ACK signal for at least one last subpacket from the first data-packet and ACK signals for all but the at least one last subpacket of the second data-packet.

16. The method of claim 15, wherein the act of receiving comprises:
receiving subpackets of the second data-packet;
distributing the subpackets to N decoders; and
decoding the subpackets with the decoders.

17. The method of claim 16, wherein the decoders comprise Viterbi decoders, and wherein the N Viterbi decoders are configured to decode the subpackets in parallel.

18. The method of claim 15, wherein the act of processing comprises:
checking the decoded subpackets to produce ACK signals corresponding to the subpackets, wherein the ACK signal is set to be of a first status if the subpacket is transmitted successfully, and is set to be of a second status otherwise;
storing the ACK signals for the subpackets of the second data-packet comprising ACK(1), ACK(2), . . . , ACK(N); and
restoring ACK(0) for the last subpacket of the first data-packet.

19. The method of claim 15, wherein the act of aggregating and sending comprises:
producing the ACK frame by aggregating ACK(0), ACK(1), ACK(2), . . . , ACK(N−1);
storing the ACK signal for the last subpacket, subpacket(N), of the second data-packet; and
sending the ACK frame back to the transmitter.

20. A method of reducing decoding delay in a communication system comprising:
receiving raw data from a higher layer, the raw data comprising video and audio data for the communication systems;
packetizing the raw data into data-packets;
encoding the data-packets;
dividing each of the data-packets into a predetermined number, N, of subpackets comprising subpacket(1), subpacket(2), . . . , subpacket(N), wherein the data-packet comprises first and second data-packets which are consecutively serially sent, wherein each of the data-packets comprises a predetermined number of subpackets;
storing the subpackets of the second data-packet, subpacket(i) with index i runs from 1 to N, in memory locations;
transmitting subpackets of the second data-packet to a receiver; and
retransmitting the restored subpackets to the receiver.

21. The method of claim 20, wherein the memory locations comprise a buffer, wherein the size of the buffer is determined by duration of one subpacket and a transmission speed of the transmitter and the receiver.

22. The method of claim 20, wherein prior to the act of retransmitting, the method further comprising:
receiving an ACK frame from a receiver, wherein the ACK frame comprises an ACK signal for a last subpacket from the first data-packet and ACK signals for all but the last subpacket of the second data-packet;
checking the received ACK frame;
determining if each of the received ACK signals corresponding to subpackets decoded in the receiver is of first or second status; and
restoring, from memory locations, the subpackets corresponding to ACK signals in the second status.

23. A method of reducing decoding delay in a communication system having a transmitter for transmitting a series of packeted and encoded data-packets, each of which comprises a predetermined number, N, of subpackets comprising subpacket(1), subpacket(2), . . . , subpacket(N), wherein the data-packets comprise first and second data-packets consecutively serially sent, comprising:
receiving the packeted and encoded subpackets of the second data-packet from the transmitter;
distributing subpackets to N decoders;
decoding subpackets with the decoders;
checking the decoded subpackets to produce ACK signals corresponding to the subpackets of the second data-packet;
storing the ACK signals comprising ACK(1), ACK(2), . . . , ACK(N) for the second data-packet to memory locations;
restoring ACK(0) for a last subpacket of the first data-packet previously sent from a memory location;
producing an ACK frame by aggregating ACK(0), ACK(1), ACK(2), . . . , ACK(N−1); and
sending the ACK frame back to the transmitter.

24. The method of claim 23, wherein the decoders comprise a plurality of Viterbi decoders, wherein the Viterbi decoders are configured to decode the received subpackets in parallel.

25. The method of claim 23, wherein the memory locations comprise a buffer, and wherein the size of the buffer is determined by duration of one subpacket and a transmission speed of the transmitter and the receiver.

26. A system for reducing decoding delay in a communication system, comprising:
means for receiving raw data from a higher layer, said raw data comprising video and audio data for the communication systems;
means for packetizing the raw data into the series of data-packets;
means for encoding the data-packet using convolution codes;
means for transmitting, by a transmitter and over wireless channels, a series of data-packets comprising first and second data-packets which are consecutively serially sent, wherein each of the data-packets comprises a predetermined number of subpackets; and
means for receiving, by the transmitter, an ACK frame from a receiver, wherein the ACK frame comprises the ACK signal for the last subpacket of the first data-packet and the ACK signals for the first (N−1) subpackets comprising subpacket(1), subpacket(2), . . . , subpacket(N−1) of the second data-packet.

27. The system of claim 26, wherein the means for transmitting comprises:
means for manipulating the memory locations;
means for dividing the second data-packet into a predetermined number, N, of subpackets comprising subpacket(1), subpacket(2), . . . , subpacket(N);
means for storing the subpackets, subpacket(i) with index i runs from 1 to N, to the memory locations; and
means for transmitting subpackets of the second data-packet to the receiver.

28. The system of claim 26, further comprises:
means for checking the received ACK frame;
means for determining if each of the received ACK signals corresponding to the subpackets decoded in the receiver is of the first or second status;
means for restoring, from the memory locations, the subpackets corresponding to the ACK signals in the second status; and
means for retransmitting the restored subpackets to the receiver.

29. A system of reducing decoding delay comprising:
means for receiving the first and second data-packets at a receiver;
means for processing the first and second received data-packets to produce an ACK signal for each of the subpackets of the first and second data-packets; and
means for aggregating and sending after receiving the second data-packet, an ACK frame to a transmitter, the ACK frame comprising an ACK signal for at least one subpacket from the first data-packet and ACK signals for all but the at least one subpacket of the second data-packet.

30. The system of claim 28, wherein the means for receiving comprises:
means for receiving the subpackets of the second data-packet;
means for distributing subpackets to N decoders; and
means for decoding subpackets with the decoders.

31. The system of claim 29, wherein the decoders comprise a plurality of Viterbi decoders, and wherein the Viterbi decoders are configured to decode the subpackets in parallel.

32. The system of claim 28, wherein the means for processing comprises:
means for checking the decoded subpackets to produce ACK signals corresponding to the subpackets, wherein an ACK signal is set to be of a first status if the subpacket is transmitted successfully, and is set to be of a second status otherwise;
means for storing the ACK signals for the subpackets of the second data-packet comprising ACK(1), ACK(2), . . . , ACK(N) to the memory locations; and
means for restoring ACK(0) for the last subpacket of the first data-packet from the memory location.

33. The system of claim 28, wherein the means for aggregating and sending comprises:
means for producing the ACK frame by aggregating ACK(0), ACK(1), ACK(2), . . . , ACK(N−1);
means for manipulating memory locations for the last subpacket, subpacket(N), of the second data-packet; and
means for sending the ACK frame back to the transmitter.
